(19) United States
(12) Patent Application Publication
(10) Pub. No.: US 2010/0112204 A1
(43) Pub. Date: May 6, 2010

(54) WATER-, OIL-, AND DIRT-REPELLENT FINISHES ON FIBERS AND TEXTILE FABRICS

(75) Inventors: Oliver Marte, Wattwil (CH); Martin Meyer, Thalwil (CH); Stefan Angehrn, Ulisbach (CH); Anita Bienz, Buetschwil (CH)

Correspondence Address: BUCHANAN, INGERSOLL & ROONEY PC, POST OFFICE BOX 1404, ALEXANDRIA, VA, 22313-1404, US

(73) Assignee: HeiQ Materials AG, Bad Zurzach (CH)

(21) Appl. No.: 12/596,377

(22) PCT Filed: Apr. 15, 2008
(86) PCT No.: PCT/CH08/00165

§ 371 Date: Dec. 18, 2009

(30) Foreign Application Priority Data
Mar. 27, 2007 (CH) 454/08
Apr. 17, 2007 (CH) 627/07

(51) Int. Cl. B05D 7/00; B32B 5/02; B05D 3/02

(52) U.S. Cl. 427/222; 428/338; 427/212; 427/372.2

(57) ABSTRACT

A particle composite for incorporation in a finish coating includes particles having various sizes from 0.01-10 μm and encased by at least one layer containing a coating mass. The particles are chemically fixable and have substantially the same function on the surface as that in the host matrix of the finish layer. Methods for producing the particle composite are disclosed, wherein hyperstructures leading to an enhancement of the oil- and dirt-repellent effect are formed by the combination of smaller and larger particles.

The invention relates to a particle composite for the finishing of fibers and textile fabrics according to Claim 1, process for the production thereof, as well as a process with use of the particle composite according to Claims 11 to 25.

Water-, oil-, and dirt-repellent finishes on textiles have already been produced for many years, whereby the requirements on the effect levels have increased by leaps and bounds with the introduction of the concepts of nanotechnology and the Lotus Effect (W. Barthlott et al., Der Lotus-Effekt: Selbstreinigende Oberflächen nach dem Vorbild Natur [Self-Cleaning Surfaces According to the Model of Nature], ITB International Textile Bulletin January 2001, pp. 8-12; E. Gärtner, Nano-Finish ersetzt herkömmliche Impränierung [Nano-Finish Replaces Conventional Impregnation], Chemische Rundschau [Chemical Review] 8 (2001), Apr. 12). The Lotus Effect published for the first time by W. Barthlott corresponds to a self-cleaning effect due to microroughness that is encountered in flowers and leaves on flower and leaf surfaces that are formed from wax crystals.

Thus, the importance of the hydrophobization chemicals that cannot be fixed chemically has dropped to the level of insignificance and that of the chemicals that can be fixed chemically, in particular the fluorocarbon resins, has increased enormously. Because of the high effect requirements demanded by the market, it is exclusively fluorocarbon resins that meet these requirements. These include high sprinkling scores (sprinkling examination according to Bundesmann, DIN 53888), high oil scores, and a very good dirt repelling capability, and all criteria themselves should be met after washing cycles or chemical cleaning operations that are performed multiple times. It is common to all hydrophobizing agents that now are found on the market that they are marketed exclusively as aqueous emulsions, and after their application on the textile material, the latter impart a more or less pronounced hydrophobic or dirt-repellent nature. The conditions of chemical cleaning resistance and oil repelling capability are satisfied only by fluorocarbon resins.

The use of fluorocarbon resins as finish chemicals for textiles now belongs to the prior art. The effects that are thus achieved with respect to the standard are very good compared to non-fluorinated hydrophobization chemicals, but the effect levels required recently cannot be provided by the use of fluorocarbon resins alone. With knowledge of the Lotus Effect (H. G. Edelmann et al., Ultrastructure and Chemistry of the Cell Wall of the Moss Rhacocarpus purpurascens: A Puzzling Architecture Among Plants, Planta 206 (1998), pp. 315-321; W. Barthlott, Self-Cleaning Surfaces of Objects and Process for Producing Same, WO/1996/004123), developments were introduced that led to a volatile increase of the effect levels. These are nanotechnologically proposed solutions that result in lotus-structured surfaces, which first and foremost considerably increase oil and dirt repelling capability (W. Barthlott, C. Neinhuis, Only That Which is Rough is Clean by Itself, Technical Review No. 10 (1999), pp. 56-57). This “key technology” for the textile industry represents the process that is described in the patent EP 1,268,919, which builds on the self-organization of methylated or fluorinated nanoparticles, by which lotus structures are produced during the drying phase, the layer applied to the textile material. The hydrophobization layers that are produced according to this process show contact angles of 70-90°, measured with heptane, in comparison to layers that consist only of fluorocarbon resin and that have a contact angle of 40-60°. The determination of the contact angles is carried out according to a measuring process that was developed for characterization of lotus structures: O. Marte, M. Hochstrasser, Characterization of Lotus-Structured Fiber and Fabric Surfaces, Melliand Textile Reports October 2005, pp. 746-750.

The drawback of the fabric equipped only with fluorocarbon resin lies in the comparison with layers that have lotus structures in their lower oil and dirt repelling capability.

The drawback of the finishes that now carry lotus structures lies in their formulations, which require considerable amounts of suitable dispersing agents for the incorporation of methylated and/or fluorinated particles (patent EP 1,268,919), which exclusively drop the effect level of the functional layers. Another drawback exists in the maintaining—not simple to carry out—of the process control conditions, which lead to the self-organization (specific agglomeration) of the nanoparticles or to the desired lotus structures (O. Marte, U. Meyer, Neue Testverfahren zur Bewertung hydrophober and superhydrophober Ausrüstungen [New Test Processes for Evaulating Hydrophobic and Superhydrophobic Finishes], Melliand Textilberichte [Melliand Textile Reports] October 2006, pp. 732-735). This is also the reason why hydrophobic multifunctional layers have not found any industrial access until now. The anti-static and bactericidal function is especially worth mentioning.

The high costs corresponding to modified nanoparticles and the safety measures that are necessary in their processing, which make necessary a minimization of the proportion of nanoparticles in the formulations, are another very significant drawback.

Another object exists in making available a formulation technique, which allows the use of various particle composites with different functions. For example, the hydrophobic and bactericidal function can be mentioned, combined in the same finishing layer.

The object of the invention is to indicate and to produce a non-nanotechnological, lotus-structured finishing layer, in particular for hydrophobization and oleophobization and for dirt repelling capability, which produces at least as good or better finish effects in comparison to a nanotechnological proposed solution.

Another object of the invention is to make available to the textile refiner a microparticle composite, which allows the refiner to combine a hydrophobizing agent, freely specified by him, in particular a fluorocarbon resin, with the particle composite, and to administer, dry and fix the formulation to the fabric with respect to the standard. For the drying and fixing conditions, only and exclusively the maintaining of the conditions preset by the reaction system are conveyed. This is distinguished in the existing process, operating according to nanotechnological principles, which require special formulation and process conditions for forming lotus structures.

The solution of the object is achieved by the production of a particle composite, which contains both like (relative to shape and chemical composition) and unlike (relative to shape and chemical composition) and primarily hydrophobically impregnated and/or coated microparticles and, if need be, nanoparticles (0.01-10 μm) that vary in size. This combination of impregnated and/or coated microparticles, and, if need be, nanoparticles of varying size yields hyperstructures that lead to an improvement of the oil- and dirt-repellent effect. The varying sizes are produced by, for example, differently guided milling processes and result in the mixing generally to a bi- or multimodal particle size distribution in the particle composite. As a result, the basis for designing the phenotype of similar structures on textile surfaces is pre-established. By differently guided dispersing processes and/or milling processes, particle sizes result that are distinguished by up to two powers of ten. Moreover, an improvement in the abrasion resistance results by the presence of coated, not specifically agglomerated microparticles, in whose wake the washability of the repellent effect (rejection effect) is also increased.

The term “non-nanotechnologically”-produced finishing layer is therefore important, since the production of this layer or the particle composite used for layer building is a top-down technology and not a bottom-up technology (Der Brockhaus Naturwissenschaft und Technik [The Brockhaus Science and Technology]), Vol. 2, pp. 1376-1377, Spektrum Akademischer Verlag GmbH Heidelberg (2003)). Below, the term ‘hydrophobizing agent’ is representative of oleophobizing and dirt-repelling chemicals.

A second proposed solution according to the invention exists in the particle impregnation, in the particle coating, or in the coating technique of the particles. By the use of reactive polymers as impregnating and/or coating material, it is possible to give the particle surfaces the same physical and chemical properties as are present in the host matrix of the finishing layer (e.g., one and the same fluorocarbon resin). As a result, premature phase separations in the finishing liquor but also in the textile substrate are avoided. The latter are the reason for an anisotropic build-up of the layer, which in turn results in a massive loss of effects (O. Marte, U. Meyer, Neue Testverfahren zur Bewertung hydrophober und superhydrophober Ausrüstungen, Melliant Textilberichte October 2006, pp. 732-735). Such a particle coating preferably consists of several overlying layers of different polymers with different functionalities. The build-up of the layer can be selected so that the layer that fills the particle pores has the greatest affinity to the inner particle surface, and the topmost layer that covers the particles shows the properties that are most similar to the host matrix. The topmost layer is generally formed by the hydrophobization polymer, which the host matrix also shows in the finishing layer. All polymers that are located in the impregnating or coating material are compounds that carry reactive groups and that in the course of the finishing process are cross-linked in a wash-proof manner.

Another proposed solution for the production of hyperstructures on the surface of microparticles or the finishing layer is the retention of substances that form gaseous products following a phase change and/or a thermal decomposition: for example, the use of a primarily apolar, aprotic solvent that boils above 100° C. in the particle coating, which during discharge from the microparticles during drying leaves behind nanoscale structures. An analogous action is achieved by the use of compounds that cleave nitrogen, CO₂ or ammonia (e.g., radical starters, hydrocarbonates, or ammonium salts), which are used instead of the solvent.

Another proposed solution of the invention is to coat this emulsifier freely starting from economical polysilicic acids (1-50 μm) that are not modified chemically. Thus, on the one hand, they are to be processed easily by the textile finisher and, on the other hand, they are to be crosslinked chemically with the hydrophobic host matrix. In this connection, any surfactants contained in fluorocarbon resins are not considered.

A special feature of the invention is the production of an emulsifier-free particle composite as an essential factor for improving these effects. As amphiphilic substances, dispersing agents and emulsifying agents lodge themselves in the boundary layer that is to be formed hydrophobically and thus, detached from the finishing concept, sorb or transport into the textile material the substances that in principle are to be repelled. Another advantage of the emulsifier-free formulation is the low LAD effect (‘laundry/air dry,’ M. Rasch, et al., Melliand Textilberichte June 2005, pp. 456-459), which is a result of the water sorption by the hydrophobization layer. By the presence of amphiphilic substances in the finishing layer, the water is physically/chemically bonded because of its dipolar nature and the formation of hydrogen bridges. As a result, elevated temperatures are necessary to desorb the water again and thus to regenerate the hydrophobization effect again.

According to the invention, a structure that is more similar to the phenotype is provided to the now known, simple lotus structures (production of a hyperstructure, W. Barthlott et al., Der Lotus-Effekt: Seibstreinigende Oberflächen nach dem Vorbild Natur, ITB International Textile Bulletin January 2001, pp. 8-12) to thus achieve an additional increase in effects relative to the oil and dirt repelling capability in comparison to the known lotus-structured coatings that can be achieved.

The production of the particle composite can be performed both as a single-stage and as a multi-stage coating process.

The one-stage coating process contains the adsorption of a polymer or of polymers from a primarily aqueous phase. In this case, the polymers should enter into a chemical bond with the particle surface to achieve high washing permanence. The effect of this is that the particles in the same process step are modified with hydroxyl- or amino-terminated silyl compounds. A possible addition of cross-linking chemicals, such as, e.g., isocyanates or α-aminoalkylating products, is based on the reaction possibilities of the polymers that are used.

Within the scope of a two-stage coating process, the particles are impregnated in a first step with a solution of an amino- and/or hydroxyl group-containing, preferably branched, water-insoluble polymer in dissolved form, on the particle surface. The polymer is generally soluble in a polar, protic solvent and/or in a nonpolar, non-protic solvent. In this coating solution, all possible ingredients that form hyperstructures can be contained, such as, e.g., special solvents and/or N₂-, CO₂- or NH₃-cleaving substances. In addition, a cross-linking system is added to this polymer solution. Only at temperatures above 80° C. does this result in the cross-linking of the polymer, or in the cross-linking of the polymer that is sorbed in and on the particle surface with the hydrophobizing agent that forms the host matrix.

The second step is used for the production of a second coating layer. It consists in the adsorption of the hydrophobizing agent, preferably a fluorocarbon resin, from the aqueous emulsion. According to the invention, any ingredients that form hyperstructures can also be added here.

In the first stage, the three-stage coating process consists of a chemical particle modification with amino- and/or hydroxyl- or glycidyl group-terminated silyl compounds, which are used in the later cross-linking with the second coating layer. The second and third coating layers show an analogous design, as it was previously described.

The particle wetting with the ingredients of the first coating layer is advantageously carried out with stirring aggregates, while the additional steps are performed in milling aggregates. In the milling operations that are carried out after the particle wetting (one-stage or multi-stage), the microparticles are reduced from an original size of 1-50 μm to the desired size. This is in the range of 0.01-2 μm, preferably in the range of 0.3-0.9 μm, whereby preferably a bimodal particle size distribution is set, e.g., 0.4 and 0.8 μm. The particle composite that is produced in this way has a particle concentration of 5-20%, preferably 10-12%, and shows virtually no tendency to sedimentation because of the particle coating and the elevated viscosity. This is true despite the absence of dispersing agents; hence, the otherwise common influence that disrupts the hydrophobization effect is eliminated.

The particles that are used for the production of the particle composite are preferably polymer silicic acids, which are reduced to the desired size in special process steps, e.g., by milling processes performed sequentially. In this case, the milled product can have a multimodal particle size distribution. In addition to the polymeric silicic acids, metal oxides, such as, e.g., Al₂O₃ or zirconium oxides or mixed oxides, are also used. To achieve a bactericidal or fungicidal function, for example, the silicon dioxide particles can be charged with elementary silver or copper and/or their oxides, or can contain the corresponding metal ions in complexed form.

Another possibility of achieving a multimodal particle size distribution is the mixing of, for example, nanoparticles with a primary particle size of 10-30 nm that are produced according to the flame process (high-temperature hydrolysis of chlorosilanes). This is in combination with particles that are adjusted to the size of 500-700 nm in the top-down process, for example by means of a milling process.

For particle modification, silyl compounds that carry amino, hydroxyl, thiol or glycidyl groups are used. Preferably used compounds are: N-2-aminoethyl-3-aminopropyltrimethoxysilane, 3-aminopropylmethyltriethoxysilane, bis(3-trimethoxysilylpropyl)amine, triamino-functional propyltrimethoxysilane, polyether propyltrimethoxysilane, 3-mercaptopropyltrimethoxysilane, and 3-glycidyloxypropyltriemthoxysilane. The amounts used of the above-mentioned silyl compounds are 0.2-10%, preferably 0.8-5%, relative to the particle material.

As hydroxyl- or amino group-containing polymers, e.g., derivatized polyacrylates, polyesters and polyurethanes are used, whose solubility in water is less than 10%, preferably less than 1%. Such products have hardly been used to date in the textile industry. The amounts used for the selected polymers are 1-40%, preferably 10-30%, relative to the particle material.

The hydrophobization chemicals are both fat-modified melamine derivatives, polyacrylates, and polyurethanes with a fatty hydrocarbon chain of C₃-C₂₄, preferably C₁₆-C₂₀, and perfluorinated fatty hydrocarbon resins with a perfluorinated fatty hydrocarbon chain of C₂-C₁₂, preferably C₄-C₈, and silicone resins. The amounts used of these product emulsions for forming a coating layer around the particles depend on their dry substance content, which is in the range of 10-30%. The amounts that are used of such products relative to the dry substances are 10-100%, preferably 20-50% relative to the particle material.

Typical commercial products that are suitable for this purpose are: Softgard M3 (soft chemicals, Italy), Oleophobol 7752 (Huntsman, Germany), Ruco-Gard AIR and Ruco-Dry DHY (Rudolf Chemie, Germany).

As cross-linking agents for chemical fixing, the polymers that are used for the particle coating, primarily polyisocyanates and α-aminoalkylating products are used. In the case of coating polymers carrying carboxyl groups, multifunctional aziridines are used as crosslinking agents.

Among the isocyanates, it is primarily the multi-functional isocyanates that are used (R—(N═C═O)ₙ; n=2 to 4). Examples of typical cross-linking agents are: 1,6-diisocyanatohexane (Bayer MaterialScience, Germany), 3-isocyanatomethyl-3,5,5-trimethylcyclohexylisocyanate (Hüls, Germany), or uretdione of 2,4-diisocyanatotoluene (Bayer MaterialScience, Germany).

The use of α-aminoalkylating products is now concentrated primarily on ethylene urea and melamine derivatives, which both are marketed as methylol and as etherified products. Examples are Knittex FEL and Lyofix CHN (Huntsman, Germany).

The aziridines are divided into aliphatic and aromatic aziridines; both are used. Typical representatives of aliphatic propyleneimine derivatives are: 1,1′-azelaoyl-bis-(2-methylaziridne) and N,N′,N″,N″′-tetrapropylene-1,2,3,4-butanetetracarboxylic acid amide. Typical representatives of aromatic propyleneimine derivatives are: toluene-2,6-dipropylene-urea (TPH) or diphenylmethane-bis-4,4′-N,N′-dipropylene urea.

The thus produced particle composite, or repellent composite, is dispersed at the textile refiner's plant in the host composite that he uses (e.g., a fluorocarbon resin with other ingredients), and it is applied in this form to the fabric. The reaction and process conditions that are presented in detail are specified by the hydrophobizing agent and the cross-linking system that are used.

By the type of composite production and because of the ingredients used for this purpose, the particle composite can be combined with the most varied host matrices, with which along with the repellent function, additional functions, so-called ‘intrinsic function layers’, result. These are, for example, very high oil repelling capabilities with slightly reduced hydrophobization effects, such as are required for protective clothing for the army and police. The use of the particle composite combined with a hydrophilically-dominated host matrix represents another combination, whereby such formulations are used in soil-release finishes. Similar combinations can be formulated for antistatic, bactericidal, abrasion-resistant and flame-retardant finishes, whereby a hydrophobic boundary layer that repels dirt is always formed on the textile material.

Caused by the emulsifier-free formulation and the use of various particle populations, which, in the particle composite, lead to a multimodal particle size distribution and form the above-mentioned hyperstructures, sprinkling scores of 5 (according to the Bundesmann test) and contact angles with heptane of over 100° result in fluorocarbon resin-containing finishing layers. This is surprising, since now known finishes that carry lotus structures have contact angles with heptane of 70-90°. In the fluorocarbon resin-free finishing layers, contact angles with water of above 100° are achieved.

### EXAMPLE 1

### Hydrophobization of Polyester Fabrics for the Outdoor Area

A polyester fabric with a square meter weight of 190 g is hydrophilized by a partial saponification process (degree of saponification of about 0.1%) with 30 g/l of 100% sodium hydroxide solution. The thus pretreated fabric is impregnated with a hydrophobization liquor, whereby a 54% liquor layer results.

In connection to the liquor layer, the fabric drying is carried out at 110-120° C., followed by the condensation process, which is performed at 150-160° C. every 2 minutes. The ingredients of the hydrophobization liquor are:

Particle composite formulation produced in one stage:

| | | |
|---|---|---|
| 100 | g/kg | Sident 10 (Degussa, Germany) |
| 15 | g/kg | Desmophen 800 (Bayer MaterialScience, Germany) |
| 70 | g/kg | Isopropanol |
| 20 | g/kg | Tubicoat Fixierer H24 (Bezema, Switzerland), |
| | | mixed intensively, then addition of: |
| 110 | g/kg | Softgard M3 (soft chemicals, Italy) |
| 685 | g/kg | Water, milling in a ball mill aggregate for 30 minutes. |

The particle formulation shows a monomodal, mean particle size distribution of 870 nm.

Hydrophobization liquor:

| | | |
|---|---|---|
| 60 | g/l | Particle-composite, produced in the one-stage coating |
| | | process |
| 18 | g/l | Lyofix CHN (ERBA, Switzerland) |
| 33 | g/l | Softgard M3 (soft chemicals, Italy) |
| 7 | g/l | MgCl₂•6 H₂O |
| 10 | g/l | Isopropanol |
| 1 | g/l | Acetic acid |
| 871 | g/l | Water |

The measured values characterizing the hydrophobization and dirt repelling capability achieved according to this finishing process are assembled in Table 1.

TABLE 1
Test Values of the Water-Rejecting and Dirt-Repelling Finish

| | | After 10 Washing |
|---|---|---|
| Test Sizes | Unwashed | Cycles at 60° C. |
| Spray Values ⁽¹⁾ | 100% | 100% |
| Sprinkling Scores ⁽²⁾ | 5 | 5 |
| Contact Angle with Heptane ⁽³⁾ | 127° | 113° |
| Unrolling Angle with Water | 21° | 26° |

⁽¹⁾ Spray test; AATCC 22 - 1996
⁽²⁾ Bundesmann; DIN 53 888
⁽³⁾ Contact Angle, O. Marte et al., Charakterisierung von “Lotus”-strukturierten Faser- und Gewebeoberflächen [Characterization of “Lotus”-Structured Fiber and Fabric Surfaces]

### EXAMPLE 2

### Hydrophobization of Polyester-Cotton Fabrics for Army Protective Clothing

A polymer cotton fabric (laminate) with a square meter weight of 180 g, printed on one side and bonded with a membrane film, is hydrophobized by means of a coating process. The coating application is 43% relative to the dry weight of the fabric.

After the coating, the drying of the fabric is carried out at 110-130° C., followed by the fixing process at 150-160° C. for 2 minutes.

Particle composite formulation, produced according to a “two-layer” process, or in a two-stage coating process:

| | | | |
|---|---|---|---|
| 1) | 100 | g/kg | Sipernat D10 (Degussa, Germany) |
| | 10 | g/kg | Aerosil R972 (Degussa, Germany) |
| | 380 | g/kg | Isopropanol |
| | 24 | g/kg | Desmophen NH 1521 (Bayer MaterialScience, |
| | | | Germany) |
| | 20 | g/kg | Tubicoat Fixierer H24 (Bezema, Switzerland), |
| | | | intensive mixing and milling for 30 minutes, |
| 2) | | | Subsequent addition of (in the milling |
| | | | aggregate): |
| | 150 | g/kg | Oleophobol 7752 (ERBA, Switzerland) |
| | 336 | g/kg | Water, milling for 20 minutes. |

The particle formulation shows a bimodal particle size distribution with mean particle sizes of 470 and 820 nm.

| | | |
|---|---|---|
| 80 | g/l | Particle composite produced in a two-stage coating process |
| 65 | g/l | Oleophobol 7752 (ERBA, Switzerland) |
| 20 | g/l | Lyofix CHN (ERBA, Switzerland) |
| 5 | g/l | MgCl₂•6 H₂O |
| 1.5 | g/l | Citric acid |
| 10 | g/l | Isopropanol |
| 1 | g/l | Acetic acid |
| 817.5 | g/l | Water |

The fabric that is coated in this way shows excellent water- and oil-repellent properties as these have the values in Table 2.

TABLE 2
Test Results of the Hydrophobically
and Oleophobically Coated Fabric

| | | After 10 Washing |
|---|---|---|
| Test Sizes | Unwashed | Cycles at 60° C. |
| Spray Values ⁽¹⁾ | 100% | 100% |
| Sprinkling Scores ⁽²⁾ | 5 | 5 |
| Contact Angle with Heptane ⁽³⁾ | >160° | 132° |
| Unrolling Angle with Water | 16° | 21° |

⁽¹⁾ Spray test; AATCC 22 - 1996
⁽²⁾ Bundesmann; DIN 53 888
⁽³⁾ Contact Angle, O. Marte et al., Charakterisierang von “Lotus”-strukturierten Faser- und Gewebeoberflächen

### EXAMPLE 3

### Hydrophobic and Bactericidal Finish of Cotton Fabrics

On a cotton-knit fabric with a square meter weight of 130 g, an impregnating liquor is applied, which contains both a particle composite that hydrophobizes the fabric surface and a bactericidal composite. The build-up of the layer enclosing the particles is achieved by a two-stage coating process (see Example 2). In the case of the hydrophobization composite, these are pure silicon dioxide particles, which are coated with a cross-linkable polymer (polyurethane, Dicrylan PGS, ERBA, Switzerland) and a fat-modified melamine resin (C₁₆-C₁₈, Phobotex FTC, ERBA, Switzerland), while silver-charged silicon dioxide particles for the bactericidal function (elementary or complex-bonded silver) are coated in an analogous way to build up a layer. The coated primary particle composites are subjected to different milling conditions. As a result, a multimodal particle size distribution develops. The mean primary particle sizes are 7 μm (pure silicon dioxide particles, before the milling process) and 20 μm (silver-charged silicon dioxide particles). By different throughput rates of the particle composites in a continuously operated ball mill, dwell times of five and eight minutes are achieved, which in combination with two different milling ball radii (1 mm and 0.6 mm) result in particle size distributions that are between 0.6-2 μm.

### Hydrophobization Liquor:

| | | |
|---|---|---|
| 80 | g/l | Silicon dioxide particle composite produced in a first |
| | | two-stage coating process |
| 75 | g/l | Phobotex FTC (ERBA, Switzerland) |
| 20 | g/l | Silver/silicon dioxide particle composite produced in a |
| | | second two-stage coating process |
| 15 | g/l | Knittex FEL (ERBA, Switzerland) |
| 8 | g/l | MgCl₂•6H₂O |
| 2 | g/l | Tartaric acid |
| 10 | g/l | Isopropanol |
| 790 | g/l | Water |

Fabric impregnation was performed with a liquid concentration of 76% relative to the dry weight of the fabric. The drying and condensation process was carried out on a tenter frame at 120 or 160° C.

TABLE 3
Test Results of the Hydrophobized, Bactericidal Fabric

| | | After 10 Washing |
|---|---|---|
| Test Sizes | Unwashed | Cycles at 60° C. |
| Spray Values ⁽¹⁾ | 100% | 100% |
| Sprinkling Scores ⁽²⁾ | 5 | 5 |
| Contact Angle with Water ⁽³⁾ | 126° | 118° |
| Unrolling Angle with Water | 23° | 27° |
| Spec. Bactericidal Activity ⁽⁴⁾ | 4.82 | 3.32 |

⁽¹⁾ Spray test; AATCC 22 - 1996
⁽²⁾ Bundesmann; DIN 53 888
⁽³⁾ Contact Angle, O. Marte et al., Charakterisierung von “Lotus”-strukturierten Faser-und Gewebeoberflächen
⁽⁴⁾ Japanese Industrial Standard JIS 1902 (Klebsiella pneumoniae, Strain DSM 789)

It is essential to the invention that a lotus-structured finishing layer be produced

on a non-nanotechnological basis that is economical to produce and that shows excellent finishing effects.

1. Particle composite for incorporation into a finishing layer, the particle composite comprising:
particles that have different sizes of from 0.01-10 μm, the particles being surrounded by at least one layer, which contains a coating material, and wherein the particles can be chemically fixed and have essentially a same function on a surface as is present in a host matrix of the finishing layer.

2. Particle composite according to claim 1, wherein the particles are polymeric silicic acids.

3. Particle composite according to claim 1, wherein the particles are elementary metals, of silver and/or copper, metal oxides, and mixtures thereof.

4. Particle composite according to claim 1, wherein the coating material is a reactive polymer whose reactive groups can be cross-linked in a wash-proof manner.

5. Particle composite according to claim 1, wherein the coating material contains silyl compounds for modification of particle surfaces, selected from a group consisting of: N-2-aminoethyl-3-aminopropyltrimethoxysilane, 3-aminopropylmethyltriethoxysilane, bis(3-trimethoxysilylpropyl)amine, triamino-functional propyltrimethoxysilane, polyether propyltrimethoxy silane, 3-mercaptopropyltrimethoxysilane and 3-glycidyloxypropyltrimethoxysilane.

6. Particle composite according to claim 1, wherein the coating-material has embedded solvents or N₂-, CO₂- and NH₃-cleaving components, and wherein the coating material forms nanoscale structures during the drying.

7. Particle composite according to claim 1, wherein the coating material contains polymer-cross-linking compounds.

8. Particle composite according to claim 1, wherein the particle composite has a monomodal or a multimodal particle size distribution.

9. Particle composite according to claim 8, wherein hyperstructures are present with a multimodal particle size distribution on the surface.

10. Particle composite according to claim 1, wherein it is surfactant-free.

11. Process for the production of a particle composite according to claim 1, wherein particles and a particle-modifying component are added together and mixed, and are reduced by wet-milling processes that are performed in sequence, and whereby hyperstructures are formed by the a combination of smaller and larger particles, which result in an increase of an oil- and dirt-repelling effect.

12. Process according to claim 11, wherein a polymer, preferably a branched, water-insoluble polymer, is used as the particle-modifying component.

13. Process according to claim 12, wherein as a particle-modifying component, a cross-linking system is added, which leads to cross-linking of the polymer only at temperatures of above 80° C.

14. Process according to claim 11, wherein an amino- and/or hydroxyl group-containing polymer in dissolved form or silyl compounds is/are added as the particle-modifying component.

15. Process according to claim 11, wherein as a particle-modifying component, a hydrophobic polymer of a fluorocarbon resin, is added.

16. Process according to claim 11, wherein solvents and/or N₂-, CO2- or NH₃-cleaving components are used as ingredients that form hyperstructures.

17. Process according to claim 11, wherein production of a particle-composite emulsifying agent takes place freely.

18. Process according to claim 11, wherein hyperstructures are produced with a multimodal particle size distribution in a finishing layer.

19. Process according to claim 18, wherein hyperstructures are produced by gaseous products in the finishing layer that are formed during drying of the finishing layer.

20. Process according to claim 11, wherein the particle composite is combined with different host matrices, by which in addition to a repellent function, additional functions, so-called ‘layers of intrinsic functions,’ are produced.

21. Process according to claim 11, wherein the particles with reactive polymers are impregnated or coated, which takes place in one stage or multiple stages.

22. Process according to claim 11, wherein the production of the particle composite is carried out non-nanotechnologically and according to a top-down process, by the particles being reduced to a desired size.

23. Method for processing fibers of a textile fabric, with a finishing layer, the method comprising:
dispersing a particle-composite into a host composite and for application to fibers and textile fabrics, whereby a hydrophobic, dirt-repelling boundary layer is always formed on the textile material; the particle composite comprising:
particles that have different sizes of from 0.01-10 μm, the particles being surrounded by at least one layer, which contains a coating material, and wherein the particles can be chemically fixed and have essentially a same function on a surface as is present in a host matrix of the finishing layer.

24. Method according to claim 23, wherein the particle composite is combined with a host matrix, by which in addition to a repellent function, additional functions, so-called “layer-intrinsic functions,” are produced.

25. Process according to claim 23, wherein the finishing layer contains a fluorocarbon resin, contact angles with heptane larger than 100°, or in a fluorocarbon resin-free finishing layer, contact angles with water of greater than 100°.
